(19) United States
(12) Patent Application Publication
(10) Pub. No.: US 2004/0179070 A1
(43) Pub. Date: Sep. 16, 2004

(54) Ink-jet recording head and ink-jet recording apparatus

(75) Inventors: Toshinobu Hamazaki, Ebina-shi (JP); Satoshi Mohri, Ebina-shi (JP); Naoki Morita, Ebina-shi (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 10/682,072

(22) Filed: Oct. 10, 2003

(30) Foreign Application Priority Data
Mar. 10, 2003 (JP) 2003-062913

(51) Int. Cl. B41J 2/05

(52) U.S. Cl. 347/62

(57) ABSTRACT

A Ta—Si—O ternary alloy thin film resistive element having a self-oxide film that is good in energy transfer efficiency to an ink and is good in erosion resistance is used as a heating element, and deterioration in service life of the Ta—Si—O ternary alloy thin film resistive element due to cavitation is prevented. A heater ejects an ink filled in the individual flow channel in the vicinity of the nozzle from the nozzle as an ink droplet through expansion of a bubble formed in the ink with heat energy from the Ta—Si—O ternary alloy thin film resistive element, and the bubble formed in the individual flow channel is connected to the atmospheric air through the nozzle.

### BACKGROUND OF THE INVENTION

1. Field of the Invention

The present invention relates to an on-demand ink-jet recording head ejecting an ink by utilizing heat energy of a Ta—Si—O ternary alloy thin film resistive element, and an ink-jet recording apparatus having the ink-jet recording head.

2. Description of the Related Art

A bubble system ink-jet recording head has been known as that used in a printer apparatus, in which a heater having an electric resistive element (hereinafter, simply referred to as a “resistive element”) as a heating element is provided in an individual flow channel filled with an ink, the ink is quickly heated to form a high-pressure bubble by applying an electric current having a pulse waveform (hereinafter, simply referred to as a “pulse”) to the resistive element, and a part of the ink in the individual flow channel is ejected as an ink droplet through expansion of the bubble. In the ink-jet recording head of this type, it is generally necessary that the resistive element of the heater is protected from cavitation upon disappearance of the bubble after ejecting the ink droplet and erosion due to the ink, and therefore, a metallic protective film formed with Ta or the like is often provided on the resistive element with an electric insulating layer intervening therebetween. However, in the case where the metallic protective film is provided on the resistive element, there arises such a problem in that thermal conduction from the resistive element to the ink is impaired due to the presence of the metallic protective film intervening between the resistive element and the ink, so as to lower the energy efficiency.

In order to cope with the problem, JP-A-55-126462 describes a recording head for improving energy efficiency and recording speed, in which a resistive element is in direct contact with an ink without provision of a protective film. However, in the case where the resistive element is in contact with the ink without a protective film, the service life of the heater is shortened by the influence of cavitation and erosion in comparison to the heater having a protective film provided on the resistive element.

JP-A-5-116308 describes an ink-jet recording apparatus satisfying both high energy efficiency and prolonged service life of a heater, in which upon using the heater having a resistive element in direct contact with an ink, cavitation is prevented by connecting a bubble formed on the heater to the outside air through a nozzle. However, the heater receives the influence of erosion by the ink even in this ink-jet recording apparatus, and therefore, the material for the resistive element is restricted to those having high strength in electrochemical reaction. Furthermore, the material for the resistive element is restricted to a narrow range in intrinsic resistivity to obtain a prescribed heating characteristics, and also it suffers severe restriction from the standpoint of processing cost and processing accuracy. Therefore, it is not easy to select a material that satisfies all the requirements as the material for the resistive element.

Japanese Patent No. 3,194,465 describes an ink-jet recording head having a Ta—Si—O ternary alloy thin film resistive element having a self-oxide film as a heater. The self-oxide film formed on the Ta—Si—O ternary alloy thin film resistive element is considerably thin as from several tens to several hundreds angstroms as compared to the conventional metallic protective film having a thickness of several thousand angstroms, and thus the heater exerts such an energy efficiency that is equivalent to that of a heater having no protective film. Furthermore, the self-oxide film is excellent in electric insulating characteristics and has such a function in that erosion of the resistive element due to the ink is prevented. However, because the self-oxide film is extremely thin, the heater is weak against the cavitation associated with mechanical impact in comparison to the heater having the metallic protective film formed with Ta or the like, and thus a sufficient service life cannot be obtained under the condition where cavitation occurs.

JP-A-7-227967 describes an ink ejecting head using a CR—Si—SiO alloy thin film resistive element as a heater, which requires no special protective film, and in this ink ejecting head, an ink on the ejecting side and an ink on the remaining side are segmented with a bubble formed on the heater to suppress generation of subdrop, which causes deterioration in printing quality. In this ink ejecting head, cavitation on the heater is prevented to suppress mechanical breakage of the heater, but damages due to erosion are increased with the resistive element having no protective film depending on the species of the ink, and there are some cases where the sufficient service life cannot be obtained.

### SUMMARY OF THE INVENTION

The invention is to provide, in view of the aforementioned circumstances, such an ink-jet recording head that uses, as a heater, a Ta—Si—O ternary alloy thin film resistive element having a self-oxide film that is good in energy transfer to an ink and good in erosion resistance, so as to prevent deterioration in service life of the Ta—Si—O ternary alloy thin film resistive element due to cavitation, and is also to provide such an ink-jet recording apparatus that uses the ink-jet recording head and consumes less electric power upon recording images.

The ink-jet recording head according to the invention contains nozzles for ejecting an ink, plural individual flow channels filled with the ink and connected to the nozzles, a substrate constituting a part of an inner wall of the individual flow channels, a Ta—Si—O ternary alloy thin film resistive element which is provided on substrate to be disposed in the vicinity of the nozzles in the individual flow channels and has a self-oxide film at least on a surface in contact with the ink, and a driving unit for generating heat energy for ejecting the ink from the nozzles with the Ta—Si—O ternary alloy thin film resistive element by applying electricity on the Ta—Si—O ternary alloy thin film resistive element, the ink filled in the individual flow channels in the vicinity of the nozzle being ejected as an ink droplet from the nozzle through expansion of a bubble formed in the ink with heat energy from the Ta—Si—O ternary alloy thin film resistive element, and the bubble formed in the individual flow channel being connected to atmospheric air through the nozzle.

The ink-jet recording apparatus according to the invention contains a ink-jet recording head according to the invention, a head driving unit for driving the ink-jet recording head along a head moving direction, and a conveying unit for conveying a recording material along an arranging direction relative to the ink-jet recording head.

According to the ink-jet recording head of the invention, the ink filled in the individual flow channel in the vicinity of the nozzle is ejected as an ink droplet from the nozzle through expansion of the bubble formed in the ink with heat energy from the Ta—Si—O ternary alloy thin film resistive element, and cavitation on the Ta—Si—O ternary alloy thin film resistive element can be prevented by connecting the bubble formed in the individual flow channel to the atmospheric air through the nozzle, whereby mechanical breakage of the Ta—Si—O ternary alloy thin film resistive element due to cavitation is prevented, and thus deterioration in service life of the Ta—Si—O ternary alloy thin film resistive element due to cavitation can be effectively prevented.

In a preferred embodiment of the invention, upon ejecting the ink in the individual flow channel as an ink droplet from the nozzle, the driving unit electrifies the Ta—Si—O ternary alloy thin film resistive element with a series of driving signals containing plural driving pulses. According to the embodiment, influence of the temperature is in difficulty exerted, and the bubble on the Ta—Si—O ternary alloy thin film resistive element can be stably discharged to the atmospheric air after ejecting the ink droplet, whereby the cavitation can be certainly prevented.

In another preferred embodiment of the invention, the driving unit electrifies the Ta—Si—O ternary alloy thin film resistive element with a series of driving signals containing a pre-pulse and a main pulse, in which the pre-pulse is for preliminary heating the ink with the Ta—Si—O ternary alloy thin film resistive element with heat energy of such an extent that no bubble is formed, and the main pulse is for heating the ink with the Ta—Si—O ternary alloy thin film resistive element to form a bubble in the ink thus preliminary heated, and a number of the pre-pulse is changed depending on a temperature of the substrate. According to the embodiment, the ejection of the ink droplet and the connection of the bubble to the atmospheric air can be prevented from being unstable due to temperature change of the substrate.

In still another preferred embodiment of the invention, time widths of the plural pulses (including the pre-pulse and the main pulse) with which the Ta—Si—O ternary alloy thin film resistive element is electrified are equalized when the ink in the individual flow channel is ejected by the driving unit as an ink droplet from the nozzle, and electrification intervals of the pre-pulse and the main pulse constituting the series of driving signals are equalized. According to the embodiment, constitutions of a control circuit and the like of the driving unit can be simplified.

In a further preferred embodiment of the invention, an electrode for electrifying the Ta—Si—O ternary alloy thin film resistive element is provided on the substrate, and the electrode is covered with the Ta—Si—O ternary alloy thin film resistive element. According to the embodiment, an additional electrode protective layer for protecting the electrode from an ink is unnecessary, whereby energy loss caused by the electrode protective layer is prevented, and thus the energy efficiency of the Ta—Si—O ternary alloy thin film resistive element can be further improved.

In a still further preferred embodiment of the invention, a diameter of the nozzle, a nozzle length from an inlet to an outlet of the nozzle, a distance from an ink contact surface of the Ta—Si—O ternary alloy thin film resistive element to the inlet of the nozzle, and the like each are substantially equal to about ½ of a length of one edge of the ink contact surface of the Ta—Si—O ternary alloy thin film resistive element. According to the embodiment, the volume of the ink droplet thus ejected can be changed while the effects obtained by the aforementioned embodiments are maintained, so as to meet demands in image quality determined by resolution and density.

According to the ink-jet recording apparatus of the invention, owing to the employment of the ink-jet recording head of the invention exerting the above effects, maintenance of the recording head, such as replacement and repair, can be redundant for a prolonged period of time, and the electric power consumption can be reduced.

### BRIEF DESCRIPTION OF THE DRAWINGS

Preferred embodiments of the present invention will be described in detail based on the following figures, wherein:

FIG. 1 is a schematic perspective view showing an ink-jet printer using an ink-jet recording head according to an embodiment of the invention;

FIG. 2 is an exploded perspective view showing a constitution of an ink-jet recording head according to an embodiment of the invention;

FIG. 3A is a plane view showing the ink-jet recording head shown in FIG. 2, and FIG. 3B is a side cross sectional view showing the same;

FIGS. 4A to 4J are side cross sectional views showing time series status of from formation to extinction of a bubble upon ejection of an ink in a recording head according to an embodiment of the invention;

FIGS. 5A to 5J are side cross sectional views showing time series status of from formation to extinction of a bubble upon ejection of an ink in a conventional recording head;

FIG. 6 is a side cross sectional view showing status change of a bubble and an ink meniscus in Model 1 of an ink-jet recording head according to an embodiment of the invention;

FIG. 7 is a side cross sectional view showing status change of a bubble and an ink meniscus in Model 2 of an ink-jet recording head according to an embodiment of the invention;

FIG. 8 is a side cross sectional view showing status change of a bubble and an ink meniscus in Model 3 of an ink-jet recording head according to an embodiment of the invention;

FIG. 9 is a side cross sectional view showing status change of a bubble and an ink meniscus in Model 4 of an ink-jet recording head according to an embodiment of the invention;

FIG. 10 is a side cross sectional view showing status change of a bubble and an ink meniscus in Model 5 of an ink-jet recording head according to an embodiment of the invention;

FIG. 11 is a side cross sectional view showing status change of a bubble and an ink meniscus in Model 6 of an ink-jet recording head according to an embodiment of the invention;

FIG. 12 is a side cross sectional view showing status change of a bubble and an ink meniscus in Model 7 of an ink-jet recording head according to an embodiment of the invention;

FIG. 13 is a side cross sectional view showing status change of a bubble and an ink meniscus in Model 8 of an ink-jet recording head according to an embodiment of the invention;

FIG. 14 is a side cross sectional view showing status change of a bubble and an ink meniscus in Model 9 of an ink-jet recording head according to an embodiment of the invention;

FIGS. 15A to 15H are graphs showing relationships of the volume of the ink droplet and the velocity of the ink droplet on the various structure parameters show in Table 1;

FIGS. 16A and 16B are graphs showing relationships of the volume of the ink droplet and the velocity of the ink droplet on the size of the heater in Model 1, Model 10, Model 11 and Model 12 of an ink-jet recording head according to an embodiment of the invention;

FIG. 17 is a graph showing a relationship between the resolution and the volume of the ink droplet determined by the structure parameters shown in Table 3, and a relationship between the resolution and the volume of the ink droplet required from image quality;

FIG. 18 is a timing chart showing a control pattern of pre-pulses and a main pulse of electricity applied to a heater according to an embodiment of the invention;

FIG. 19A is a plane view showing a structure of a heater according to an embodiment of the invention, and FIG. 19B is a side cross sectional view showing the same; and

FIG. 20A is a plane view showing a structure of a conventional heater, and FIG. 20B is a side cross sectional view showing the same.

### DESCRIPTION OF THE PREFERRED EMBODIMENTS

An ink-jet recording head according to preferred embodiments of the invention and an ink-jet printer having the ink-jet recording head applied thereto will be described below with reference to the drawings.

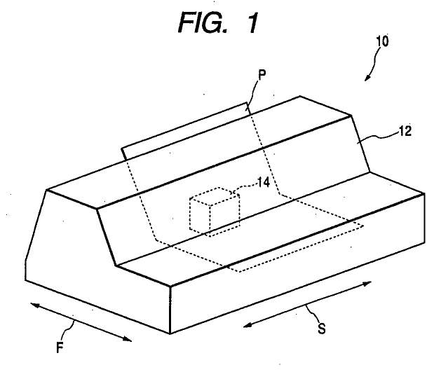

An ink-jet printer having an ink-jet recording head (hereinafter, simply referred to as a “recording head”) according to an embodiment of the invention will be briefly described with reference to FIG. 1. An ink-jet printer 10 (hereinafter, simply referred to as a “printer”) is to record an image corresponding to image information input from an information processing apparatus, such as a personal computer, on recording paper P with an ink. The printer 10 has a casing 12 as an outer chassis, and an ink-jet recording head (hereinafter, simply referred to as a “recording head”) 14 is arranged in the casing 12. The printer 10 also has a head driving mechanism (not shown in the figure) for moving the recording head 14 in a prescribed primary scanning direction (the direction shown by the arrow S in FIG. 1) and a paper feeding mechanism (not shown in the figure) for feeding the recording paper P in a subsidiary scanning direction (the direction shown by the arrow F in FIG. 1) perpendicular to the primary scanning direction.

The recording head 14 has plural nozzles arranged along the conveying direction as described later, and the nozzles are arranged with an interval corresponding to the resolution of an image to be recorded. Ink droplets each having a minute volume (from 2 to 16 pL in this embodiment) can be ejected from the respective nozzles. In the printer 10, ejection and termination of the ejection of ink droplets from the nozzles are controlled corresponding to image information while the recording head 14 is moved in the primary scanning direction at a prescribed scanning rate, and image formation is made on a prescribed number of primary scanning lines on the recording paper P with the recording paper P being moved by a prescribed unit interval as synchronized with the image formation on the primary scanning lines, whereby recordation of a two-dimensional image on the recording paper P is realized.

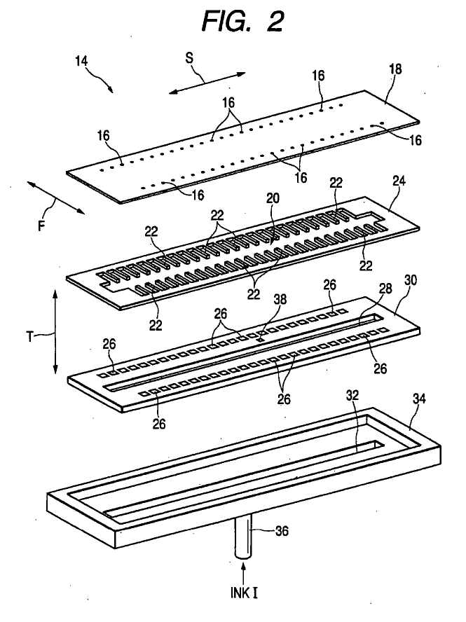

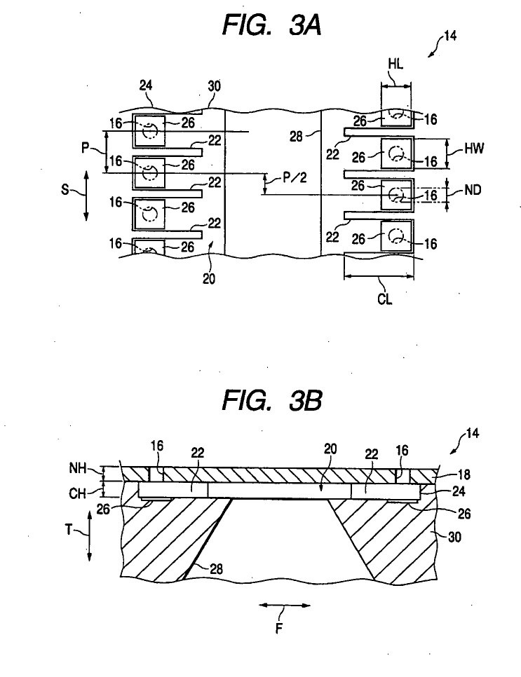

A constitution of a recording head according to the embodiment of the invention is described in FIG. 2 and FIGS. 3A and 3B. The recording head 14 has a nozzle plate 18 having plural nozzles 16 perforated therein, a resin plate 24 having a header 20 and individual flow channels 22 formed therein, an Si substrate 30 having heaters 26 and an inlet 28 formed therein, a manifold 34 having an ink feeding port 32 formed therein connected to the inlet 28, and an ink feeding pipe 36 connected to the manifold 34 for feeding an ink to the ink feeding port 32. In the recording head 14, the nozzle plate 18, the resin plate 24 and the Si substrate 30 are unified by accumulating in the thickness direction (the direction shown by the arrow T in FIG. 2), and the assembly is fixed on the manifold 34.

The nozzle plate 18 is produced with a material, such as a resin film and a metallic plate, to be processed, in which the nozzles 16 are formed by laser processing or etching. The resin plate 24 is formed, for example, with synthetic photosensitive epoxy resin (SU-8, trade name), in which the individual flow channels 22 and the header 20 are formed by etching. The heaters 26 on the Si substrate 30 each are produced in such a manner that a Ta—Si—O ternary alloy thin film resistive element (hereinafter, simply referred to as a “thin film resistive element”) 40 having a thickness of about 1,000 Å is formed by a reactive sputtering process using Ta and Si as a target, and then a self-oxide film having a thickness of from several tens to several hundreds angstroms is formed on the resistive element through a heat treatment. The inlet 28 penetrating the Si substrate 30 is formed by anisotropic etching. In addition to the heaters 26 and the inlet 28, the Si substrate 30 further has, while not shown in the figures, electrodes, driver transistors, logic circuits, pads and the like formed through a known LSI process.

A head driving circuit (not shown in the figure) is connected to the Si substrate 30 of the recording head 14, and a driving control signal output from the head driving circuit is input to a logic circuit on the Si substrate 30 through the pad, whereby signals (bit signals) for driving driver transistors corresponding to the respective bits are output from the logic circuit. One end of the heater 26 is connected to a common electrode, and the other end thereof is connected to a signal electrode. The signal electrode is connected to the driver transistor. According to the configuration, the driver transistor is driven by inputting the driving control signal to electrify with pulses the thin film resistive elements corresponding to the respective bits.

The ink feeding pipe 36 connects the manifold 34 to an ink tank (not shown in the figure), and the ink in the ink tank is fed to the header 20 of the resin plate 24 through the ink feeding pipe 36, the ink feeding port 32 and the inlet 28, and flowed from the header 20 into the individual flow channels 22, which are branched in a comb tooth form. In the non-operation state of the head, the capillary attraction caused by the ink meniscus in the nozzle 16 is balanced with the negative pressure occurring in the ink tank to make the ink in the individual flow channels 22 in a static state.

The plane view shown in FIG. 3A and the cross sectional view shown in FIG. 3B indicate the individual flow channels, the heaters and the nozzles of the recording head. The nozzle plate 18 has, as shown in FIG. 2, two rows of plural nozzles 16, which are linearly arranged in the subsidiary scanning direction. The interval (pitch) P of the nozzles 16 on the nozzle rows (see FIG. 3A) is 42 μm and the nozzles 16 on one row and the nozzles 16 of the other row are arranged as staggered each other by a half of the interval.

The plane shape along the surface of the Si substrate 30 of the heater 26 is a substantially square shape from the standpoint of axisymmetry to the nozzle 16, the heater resistance determined by the aspect ratio and easiness of production, such as workability. For example, in the case where the plane shape of the heater 26 is a rectangular shape having a large aspect ratio, the axisymmetry to the nozzle 16 is lowered, whereby it is liable that the ejection directionality and the energy efficiency are deteriorated, and the heater resistance is largely fluctuated to cause problems on driving. The problems on driving referred herein means the following phenomena. For example, in the case where the aspect ratio is too larger than 1, the heater resistance becomes large, and it is necessary to increase the driving voltage, whereby the driver transistor and the power supply necessarily become large. In the case where the aspect ratio is too smaller than 1, on the other hand, the heater resistance becomes small, and it is necessary thereby that the size of the electrode is increased for increasing the driving current with reduction of the resistance.

The shape of the flow channel of the individual flow channel 22 along the surface of the Si substrate 30 is a rectangular shape with the longitudinal direction thereof being in the primary scanning direction. That is, in general, it has been often employed that a narrowed part is provided at an end of the individual flow channel 22 on the side of the inlet 28 to adjust the proportion of the pressure of the bubble that escapes to the inlet, but in the case where the dimensional accuracy of the narrowed part is not sufficiently high, it is liable that the ejection characteristics of the respective nozzles are fluctuated. Accordingly, the shape of the flow channel of the individual flow channel 22 employed is a simple rectangular shape.

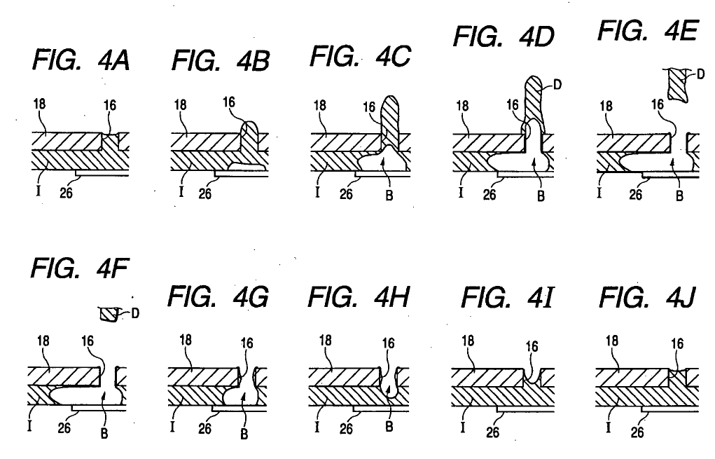

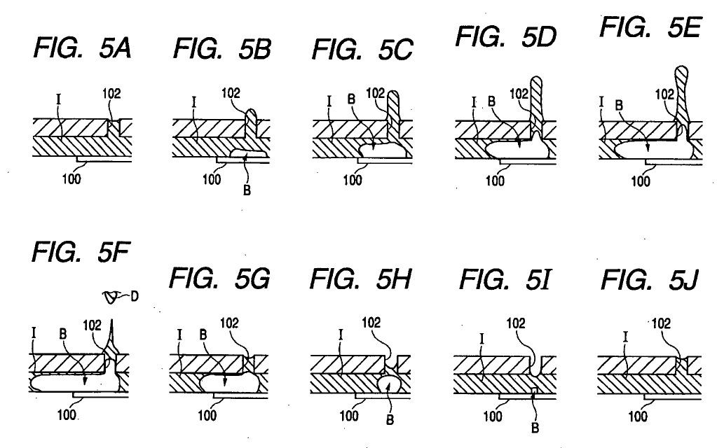

FIGS. 4A to 4J show the time series status of from formation to extinction of a bubble upon ejection of an ink in the recording head, and in comparison thereto, FIGS. 5A to 5J show the time series status of from formation to extinction of a bubble upon ejection of an ink in a conventional recording head.

The status of the bubble upon ejection of an ink in the conventional recording head will be firstly described. A heater 100 in the initial state shown in FIG. 5A is electrified with driving pulses having a prescribed pattern to cause phase change in a part of an ink I on the heater 100 through quick heating, whereby a bubble B having high pressure is formed on the heater 100 as shown in FIG. 5B. The bubble B is expanded with an inertial force of the ink I generated by the high pressure as shown in FIGS. 5C to 5E, and the interior pressure of the bubble B is reduced with the expansion. At the time when the inertial force and the interior pressure thus reduced are balanced, the bubble B has the maximum volume as shown in FIG. 5F.

After reaching the maximum volume, the bubble B then contracts by receiving the static pressure of the ink I as shown in FIGS. 5G and 5H The bubble B is then extinct on the heater 100 as shown in FIG. 5I to cause cavitation upon disappearing. In the course of from formation to extinction of the bubble B, an ink droplet D having a prescribed volume is ejected from the nozzle 102 through the action of expansion and contraction of the bubble B as shown in FIG. 5F. After ejecting the ink droplet D, the ink I is again fed from the individual flow channel 104 to the nozzle 102 by the capillary force as shown in FIG. 5J.

In the conventional recording head as described in the foregoing, cavitation occurs upon extinction of the bubble B on the heater 100, and the repeated occurrence of cavitation brings about mechanical breakage of the self-oxide film on the Ta—Si—O ternary alloy thin film resistive element in the heater 100 to shorten the service life of the heater.

The status of the bubble upon ejection of an ink in the recording head, according to an embodiment of the invention will be then described. A heater 26 in the initial state shown in FIG. 4A is electrified with pulses to form a bubble B having high pressure on the heater 26 as shown in FIG. 4B. The bubble B is expanded with an inertial force of the ink I generated by the high pressure as shown in FIGS. 4C to 4D. The bubble B ejects an ink droplet D from the nozzle 16 through the expanding process thereof as shown in FIG. 4E, and is connected to the atmospheric air through the nozzle 16 at the substantially same time as the ejection of the ink droplet D. The bubble B connected to the atmospheric air contracts with a low pressure gas inside discharged from the nozzle 16 after the ejection of the ink droplet D as shown in FIGS. 4F to 4H, and is then extinct except for a concave meniscus remaining in the nozzle 16 as shown in FIG. 4I. Thereafter, the ink is again fed by the capillary force in the nozzle 16 as shown in FIG. 4J.

In the series of operation of the recording head 14 according to the embodiment of the invention upon ejection of the ink described in the foregoing, no cavitation occurs on the heater 26, and thus no mechanical breakage due to cavitation occurs in the Ta—Si—O ternary alloy thin film resistive element having a self-oxide film constituting the heater 26. The heater 26 herein contains a Ta—Si—O ternary alloy thin film resistive element having a thickness of about 1,000 Å having thereon a self-oxide film having a thickness of from several tens to several hundreds angstroms formed by a thermal oxidation treatment. The heater 26 is good in transmission efficiency in comparison to a conventional heater having a metallic protective film, such as Ta, and erosion of the contact surface thereof is prevented with the self-oxide film.

The structure of the recording head 14 that enables the aforementioned ink ejecting operation will be specifically described. The parameters determining the characteristics of the recording head 14 (structure parameters) include the heater width HW, which is the width of the surface of the heater 26 along the primary scanning direction, the heater length HL, which is the width of the surface of the heater 26 along the subsidiary scanning direction, the nozzle diameter ND, the individual flow channel width CW, which is the width of the individual flow channel 22 along the primary scanning direction, the individual flow channel length CL, which is the length of the individual flow channel 22 along the subsidiary scanning direction, the nozzle length (height) NH, which is the length of the nozzle 16 along the thickness direction, and the individual flow channel height CH, which is the distance between the surface of the heater 26 and the inlet of the nozzle 16, as shown in FIGS. 3A and 3B. Because the plane shape of the heater 26 of this embodiment is square, the heater width HW and the heater length HL are substantially the same as each other.

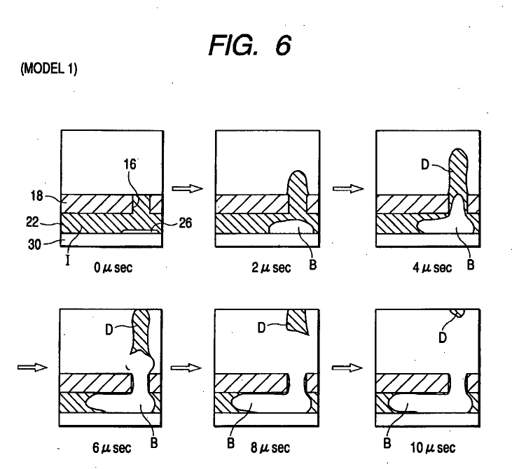

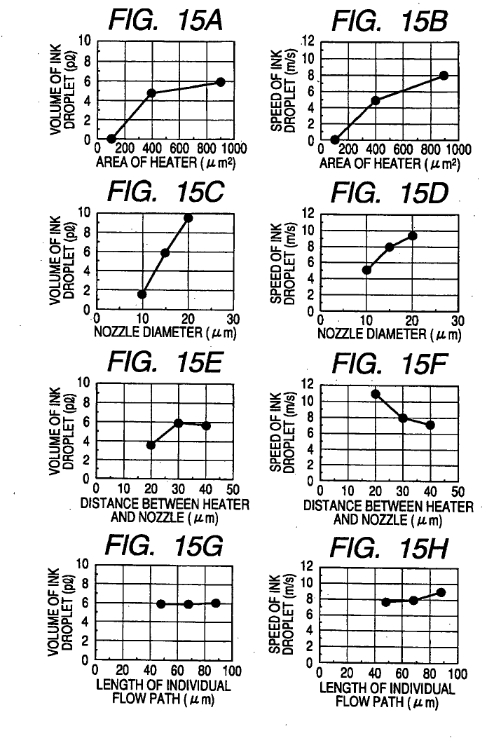

Table 1 below shows calculation results of ejection conditions of an ink droplet D with respect to the structural parameters obtained by simulation experiments with computers. FIGS. 6 to 14 show conditions of the bubble B and the ink meniscus in Models 1 to 9 obtained through the simulation experiments, and FIGS. 15A to 15H are graphs showing the relationships of the volume of the ink droplet and the velocity of the ink droplet on the various structural parameters shown in Table 1. The simulation experiments are carried out by using a fluid analysis software, FLOW-3D (a trade name, produced by Flow Science Inc.). As an initial condition herein, a bubble B having such a pressure that is considered as being appropriate from the forepast simulation results and experimental results is placed on the heater 26. As physical properties of the ink I, it is assumed that the specific gravity is 1.0, the viscosity is 2.0 mPa·s, and the surface tension is 37 mN/m.

TABLE 1

| | Heater | Nozzle | Nozzle | Flow channel | Flow channel | Flow channel | | Velocity | |
|---|---|---|---|---|---|---|---|---|---|
| | size | diameter | length | height | length | width | Volume of | of ink | |
| | HW × HL | ND | NH | CH | CL | CW | ink droplet | droplet | Operation |
| Model No. | (μm × μm) | (μm) | (μm) | (μm) | (μm) | (μm) | (pL) | (m/sec) | condition |
| Model 1 | 30 × 30 | 15 | 15 | 15 | 68 | 34 | 5.9 | 8.0 | good |
| Model 2 | 20 × 20 | 15 | 15 | 15 | 68 | 34 | 4.8 | 5.0 | low velocity of |
| | | | | | | | | | ink droplet |
| Model 3 | 10 × 10 | 15 | 15 | 15 | 68 | 34 | 0.0 | 0.0 | ink droplet not |
| | | | | | | | | | ejected |
| Model 4 | 30 × 30 | 10 | 15 | 15 | 68 | 34 | 1.6 | 5.1 | bubble not |
| | | | | | | | | | discharged |
| Model 5 | 30 × 30 | 20 | 15 | 15 | 68 | 34 | 9.6 | 9.4 | much splash |
| Model 6 | 30 × 30 | 15 | 10 | 10 | 68 | 34 | 3.6 | 11.0 | much splash |
| Model 7 | 30 × 30 | 15 | 20 | 20 | 68 | 34 | 5.7 | 7.2 | bubble not |
| | | | | | | | | | discharged |
| Model 8 | 30 × 30 | 15 | 15 | 15 | 48 | 34 | 5.9 | 7.7 | good |
| Model 9 | 30 × 30 | 15 | 15 | 15 | 88 | 34 | 6.1 | 9.0 | good |

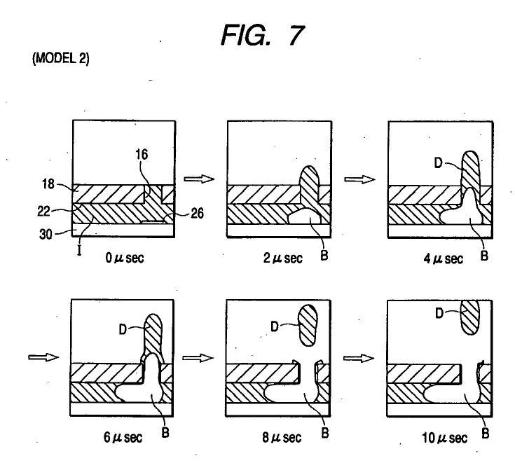

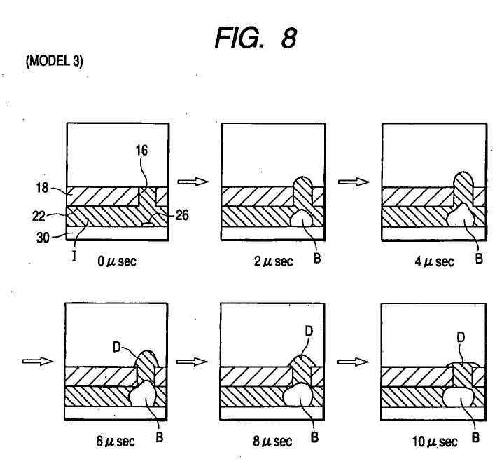

In Models 1 to 3 in Table 1, the dimension of one edge of the surface of the heater 26 in contact with the ink I (i.e., the heater size) is decreased by 10 μm. Since the nozzles 16 are arranged at an interval (pitch) of 42 μm in the recording head 14 of this embodiment, the heater size of 30 μm×30 μm (Model 1) is substantially the upper limit. As compared to Model 1 (see FIG. 6), Model 2 having a reduced heater size of 20 μm×20 μm (see FIG. 7) exhibits that the volume and the velocity of the ink droplet D in the recording head 14 are reduced. Furthermore, as compared to Model 1, Model 3 having a further reduced size of the nozzle 16 of 10 μm×10 μm (see FIG. 8) exhibits that no ink droplet D can be ejected from the nozzle 16.

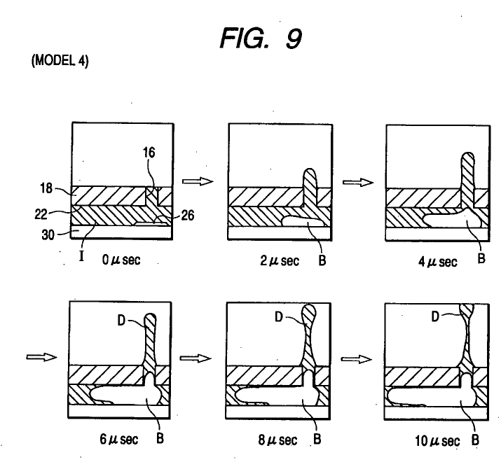

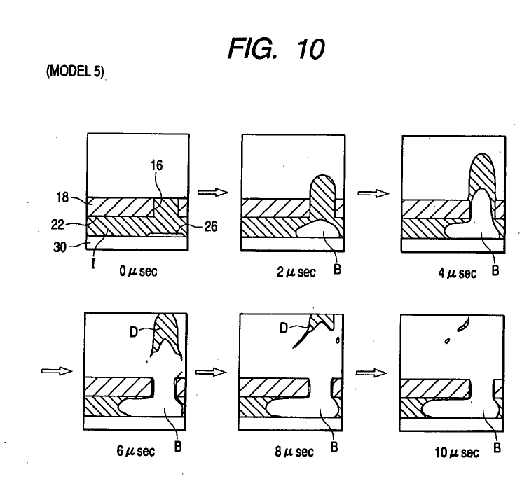

As compared to Model 1 having a nozzle diameter ND of 15 μm, Model 4 having a reduced nozzle diameter ND of 10 μm (see FIG. 9) exhibits that the bubble B formed on the heater 26 is not connected to the atmospheric air, and the volume and the velocity of the ink droplet D are reduced. On the other hand, as compared to Model 1, Model 5 having an enlarged nozzle diameter ND of 20 μm (see FIG. 10) exhibits that the shape of the ink droplet D suffers large distortion, and small droplets of the ink I are scattered to cause splash, which brings about deterioration in image quality.

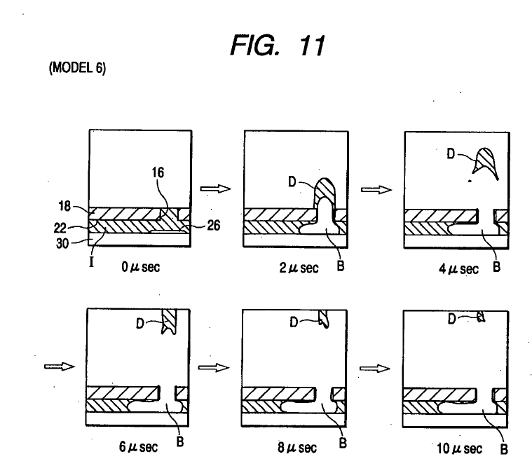

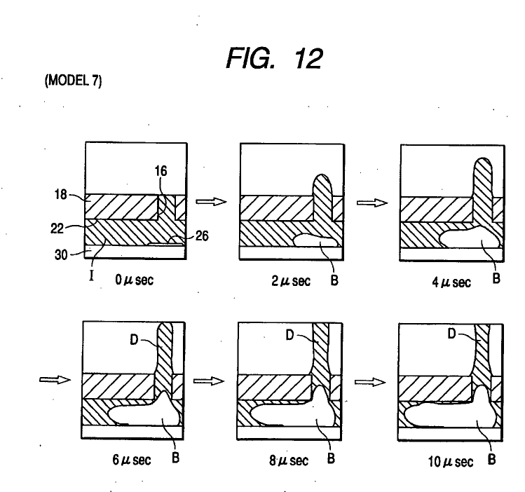

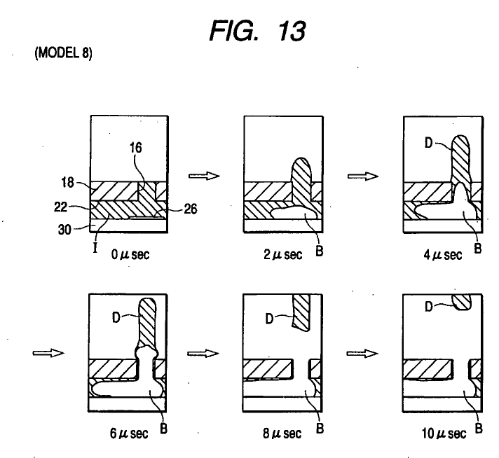

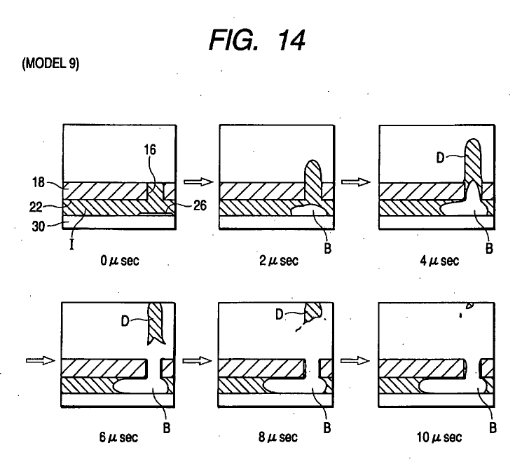

As compared to Model 1 having a nozzle length NH of 15 μm, Model 6 having a reduced nozzle length NH of 10 μm (see FIG. 11) exhibits that the velocity of the ink droplet D is increased, but splash is liable to occur. On the other hand, Model 7 having an enlarged nozzle length NH of 20 μm (see FIG. 12) exhibits that the bubble B is not discharged to the atmospheric air. With respect to the individual flow channel length CL, there is no large difference in the connection condition of the bubble B to the atmospheric air and the volume and the velocity of the ink droplet D among Model 1 having CL of 68 μm Model 8 having CL of 48 μm (see FIG. 13) and Model 9 having CL of 88 μm (see FIG. 14).

It is understood from the results shown in Table 1 having been described hereinabove that in order to discharge the bubble B to the atmospheric air and to prevent occurrence of splash of the ink while maintaining the volume and the velocity of the ink droplet D, the heater size and the dimensions of the respective parts of the individual flow channel 22 are appropriately configured based on the structural parameters including the dimensional proportions in Model 1 as the standard.

In view of the foregoing, simulation is carried out in the following manner. Such a recording head 14 is used that has a nozzle diameter ND, a nozzle length NH and an individual flow channel height CH, which are the same as each other as similar to Model 1 but are set at ½ of the length of one edge of the heater 26 (hereinafter, referred to as a “heater length”), respectively, and the heater size is changed stepwise. The results of the simulation are shown in Table 2 below.

TABLE 2

| | | Nozzle | Nozzle | Flow channel | Flow channel | Flow channel | | | |
|---|---|---|---|---|---|---|---|---|---|
| | Heater size | diameter | length | height | length | width | Volume of | Velocity of | |
| | HW × HL | ND | NH | CH | CL | CW | ink droplet | ink droplet | Operation |
| Model No. | (μm × μm) | (μm) | (μm) | (μm) | (μm) | (μm) | (pL) | (m/sec) | condition |
| Model 10 | 24 × 24 | 12 | 12 | 12 | 56 | 28 | 2.9 | 7.7 | good |
| Model 11 | 36 × 36 | 18 | 18 | 18 | 80 | 40 | 13.0 | 7.2 | good |
| Model 12 | 42 × 42 | 21 | 21 | 21 | 92 | 46 | 16.0 | 6.9 | good |

As compared to Model 1 having a heater size of 30 μm×30 μm, the ejection condition of the ink droplet D is good in Model 10 having a reduced heater size of 24 μm×24 μm, Model 11 having an enlarged heater size of 36 μm×36 μm, and Model 12 having a further enlarged heater size of 42 μm×42 μm.

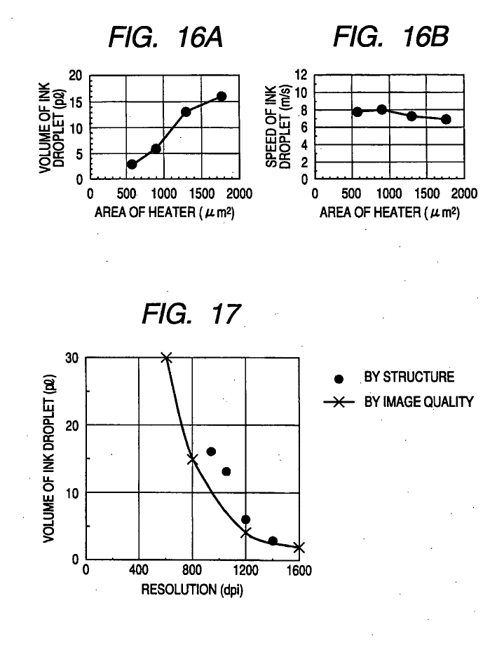

FIGS. 16A and 16B show relationships of the volume and the velocity of the ink droplet D on the heater size in Model 1, Model 10, Model 11 and Model 12 of the ink-jet recording head 14. It is understood from FIGS. 16A and 16B that in the recording head 14 having the prescribed structural parameters, the volume of the ink droplet D can be changed over a wide range by changing the heater size with the velocity of the ink droplet D being substantially not changed. Assuming that the margin for ensuring the width of a wall and the like for forming the individual flow channels 22 with respect to the heater width HW is 12 μm in the respective recording heads 14, the intervals of the nozzles 16 (nozzle pitches) along the arrangement direction thereof (i.e., the subsidiary scanning direction) in the respective recording heads 14 are as shown in Table 3 below.

TABLE 3

| Heater size | Volume of ink | Nozzle pitch | Nozzle density | Resolution |
|---|---|---|---|---|
| (μm × μm) | droplet (pL) | (μm) | (dpi) | (dpi) |
| 24 × 24 | 2.9 | 36 | 706 | 1,411 |
| 30 × 30 | 5.9 | 42 | 605 | 1,210 |
| 36 × 36 | 13.0 | 48 | 529 | 1,058 |
| 42 × 42 | 16.0 | 54 | 470 | 941 |

In the case where the two rows of the nozzles are arranged as staggered each other by a half of the interval as shown in FIG. 2, the nozzle pitches of the nozzles 16 in one of the nozzle rows shown in Table 3 provide the numbers of nozzles per 1 inch (i.e., nozzle density) in each recording head 14 and the numbers of pixels per 1 inch in the recorded image (i.e., resolution) as shown in Table 3.

FIG. 17 shows a relationship between the resolution and the volume of the ink droplet D determined by the structure parameters shown in Table 3, and a relationship between the resolution and the volume of the ink droplet D required from image quality. The relationship between the resolution and the volume of the ink droplet D determined by the structure parameters is plotted with black circles, and the relationship between the resolution and the volume of the ink droplet D required from image quality is plotted with crosses.

It is understood from FIG. 17 that the resolution and the volume of the ink droplet D determined by the structural parameters are relatively approximate to the resolution and the volume of the ink droplet D required from image quality, and thus they can be further approximate to those required from image quality by finely adjusting the heater size and the dimensions of the individual flow channel 22. However, the relationship between the resolution and the volume of the ink droplet D required from image quality generally somewhat varies depending on the ink used and the paper quality of the recording paper P.

In the conventional recording head where the bubble B formed on the heater 100 is not connected to the atmospheric air as shown in FIG. 5, it has been well known that the temperature of the head is frequently changed depending on the environmental temperature, the pattern density of the printed pattern and the like when the time length and the number of electrification of the driving pulses are constant, and therefore, the maximum volume of the bubble B formed on the beater 100 is changed under the influence thereof to change the volume and the velocity of the ink droplet D. There are generally such tendencies that when the head temperature rises, the maximum volume of the bubble B is increased, and the volume and the velocity of the ink droplet D are increased.

In the recording head 14 according to this embodiment, on the other hand, the bubble B formed on the heater 26 is connected to the atmospheric air before reaching the maximum volume, and upon changing the head temper, the balance between the heater size and the dimensions of the individual flow channel 22 thus adjusted is disrupted to make the ejection condition of the ink droplet D unstable, whereby there is such a possibility that the prescribed volume and velocity of the ink droplet D cannot be obtained. In the recording head 14, accordingly, the ejection condition of the ink droplet D is stabilized by changing the electrification pattern of the driving pulses corresponding to the head temperature. The head temperature referred herein may be basically that of such an arbitrary part in the recording head 14 that is in contact with the ink I and is sufficiently proximate to the heater. In this embodiment, the surface temperature of the Si substrate 30, which exerts particularly large influence on the ink droplet D, is designated as the head temperature, and the electrification pattern of the driving pulses is changed with the head temperature as the control parameter.

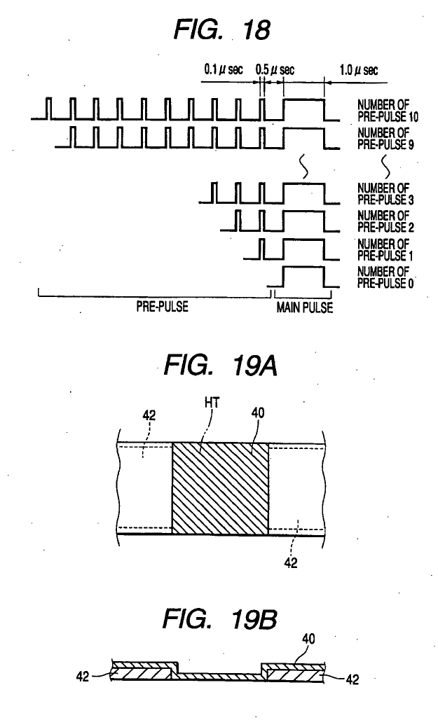

Specifically, upon ejecting an ink droplet D in the recording head 14 of this embodiment, a series of driving signals containing one or plural pre-pulses and one main pulse is electrified on the heater 26 as shown in FIG. 18. Herein, the time width of the pre-pulse is 0.1 μsec, the time width of the main pulse is 1 μsec, and the electrification interval of the pulses, i.e., the period from pulse off to pulse on, is 0.5 μsec, which are fixed. The number of the pre-pulses thus electrified (pre-pulse number) is appropriately changed within a range of from 0 to 10.

The results of observation on the ejection condition of the ink droplet D with the head temperature and the pre-pulse number as parameters are shown in Table 4 below. The pre-pulse number that provides good ejection condition is shifted depending on the head temperature. It is understood from the results in Table 4 that a too large pre-pulse number provides much splash, whereas a too small pre-pulse number brings about a low velocity of the ink droplet, whereby the ejection becomes unstable or impossible.

TABLE 4

| Head | | | | | | | | | | | |
|---|---|---|---|---|---|---|---|---|---|---|---|
| temperature | Pre-pulse number | | | | | | | | | | |
| (° C.) | 0 | 1 | 2 | 3 | 4 | 5 | 6 | 7 | 8 | 9 | 10 |
| 20 | B | B | B | B | B | B | B | B | B | A | A |
| 25 | B | B | B | B | B | B | B | B | A | A | C |
| 30 | B | B | B | B | B | B | B | A | A | C | C |
| 35 | B | B | B | B | B | B | A | A | C | C | C |
| 40 | B | B | B | B | B | A | A | C | C | C | C |
| 45 | B | B | B | B | A | A | C | C | C | C | C |
| 50 | B | B | B | A | A | C | C | C | C | C | C |
| 55 | B | B | A | A | C | C | C | C | C | C | C |
| 60 | B | A | A | C | C | C | C | C | C | C | C |
| 65 | A | A | C | C | C | C | C | C | C | C | C |

Note
A: good in ejection condition
B: low in velocity of ink droplet, or unable to eject
C: much splash

As shown in FIG. 2, the recording head 14 has a temperature sensor 38, such as thermistor, on the surface of the Si substrate 30, and the temperature sensor 38 detects the temperature of the Si substrate 30 and outputs the detected signal to the head driving circuit. Upon ejecting the ink droplet D, the head driving circuit selects a number of pre-pulses corresponding to the temperature detected by the temperature sensor 38, and outputs a driving control signal corresponding to the number of pre-pulses thus selected to the logic circuit of the Si substrate 30. According to the operation, the logic circuit drives the driver transistors with the bit signals corresponding to the driving control signal, whereby pre-pulses in the number thus selected are electrified on the heater 26 by the driver transistors, and then one main pulse is electrified thereon.

In the recording head 14 according to this embodiment described in the foregoing, the number of pre-pulses electrified on the heater 26 is changed depending on the head temperature upon ejecting the ink droplet D, whereby deterioration in ejection condition of the ink droplet D associated with change in temperature can be prevented. Therefore, good ejection condition of the ink droplet D can be constantly maintained irrespective of the head temperature, and the range of the head temperature where the ejection condition of the ink droplet D is maintained good can be sufficiently wide.

In the recording head 14, furthermore, the time widths of the respective pre-pulses are constant, and the electrification intervals of the pre-pulse and the main pulse are also constant, whereby the electrical control flow can be simplified, and thus the constitutions of the driving circuits, such as the logic circuit and the driving transistors, can also be simplified. The number of pre-pulses thus electrified may also be used for compensating fluctuation in ejection characteristics of the ink droplet D caused by the individual difference of the recording head 14.

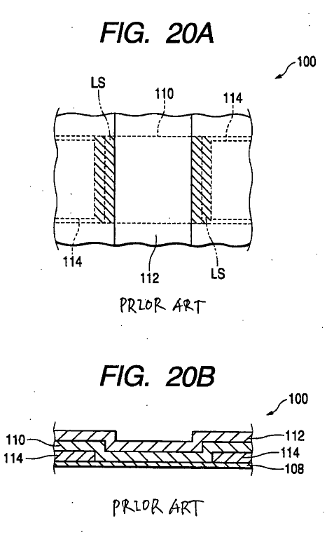

FIGS. 19A and 19B show a heater according to this embodiment using a Ta—Si—O ternary alloy thin film resistive element having formed thereon a self-oxide film as a heating element, and FIGS. 20A and 20B show a conventional heater having a thin film resistive element having formed thereon a metallic protective layer.

In order for comparison to the heater 26 according to this embodiment, the structure of the heater 100 of the conventional recording head (see FIGS. 5A to 5J) will be described. As shown in FIG. 20B, the heater 100 is provided with a thin film resistive element 108 formed on an Si substrate, an electrode 114 is formed on the thin film resistive element 108, and a metallic protective film 112 is further formed on the electrode 114 through an electric insulating layer 110. The thin film resistive element 108 is formed, for example, with TaN as a material to a thickness of about 1,000 Å. The electrode 114 is formed, for example, with aluminum as a material to a thickness of about 5,000 Å. The electric insulating layer 110 is formed, for example, with SiN or SiO₂ as a material to a thickness of about 2,000 Å. The metallic protective layer 112 is formed, for example, with Ta as a material to a thickness of about 2,000 Å.

In the heater 100 described in the foregoing, however, major part of heat energy generated from the regions (hatched regions in FIG. 20A) LS in the vicinity of the tip ends of the electrode 114 in the heat generating region with the thin film resistive element 108 is absorbed by the electric insulating layer 110 and the metallic protective layer 112 to cause energy loss, and thus the transmission efficiency of heat energy from the thin film resistive element 108 to the ink I is significantly lowered.

In the heater 26 according to this embodiment as shown in FIGS. 19A and 19B, on the other hand, a pair of electrodes 42 are formed on the Si substrate 30, and the electrodes 42 are arranged in such a configuration that the tip ends thereof are opposed to each other. A resistive element 40 is formed to a thickness of about 1,000 Å to cover the pair of electrodes 42, and the region between the tip ends of the pair of electrodes 42 is a heat generating region (hatched regions in FIG. 19A) HT. An extremely thin self-oxide film (not shown in the figures) having a thickness of from several tens to several hundreds angstroms is formed on the surface layer part of the resistive element 40.

According to the heater 26 of this embodiment, as compared to the conventional heater 100 shown in FIGS. 20A and 20B, an electric insulating layer and a protective layer do not intervene between the heater and the ink I, but only the self-oxide film having a far smaller thickness and a smaller heat capacity than these layers intervenes, whereby heat energy can be effectively transferred from the resistive element 40 to the ink I, and the electric power consumption upon recording images can be easily reduced by applying the same to the printer 10.

In another preferred embodiment, the ink contact surface has an area within a range of from 500 to 1,800 μm².

In a further preferred embodiment, the ink in the individual flow channel is heated with the Ta—Si—O ternary alloy thin film resistive element so that the ink droplet thus ejected from the nozzle has a volume of from 2 to 16 pL.

In a still further preferred embodiment, the plural nozzles are arranged in an arranging direction thereof perpendicular to a head moving direction, which is a direction along which the ink-jet recording head is moved upon recording on a recording material, and a pitch of the plural nozzles along the arranging direction is a length corresponding to a resolution of from 800 to 1,600 dpi.

As described in the foregoing, according to the ink-jet recording head of the invention, the Ta—Si—O ternary alloy thin film resistive element having a self-oxide film, which is good in energy transfer efficiency to an ink and is resistant to erosion, is used as a heat generating element, and deterioration in service life of the Ta—Si—O ternary alloy thin film resistive element due to cavitation can be prevented.

According to the ink-jet recording apparatus of the invention, the ink-jet recording head of the invention is used, whereby electric power consumption upon recording images can be effectively reduced.

The entire disclosure of Japanese Patent Application No. 2003-062913 filed on Mar. 10, 2003 including specification, claims, drawings and abstract is incorporated herein by reference in its entirety.

What is claimed is:

1. An ink-jet recording head comprising:
a plurality of nozzles for ejecting an ink;
a plurality of individual flow channels filled with the ink and connected to the plurality of nozzles;
a substrate constituting a part of an inner wall of the plurality of individual flow channels;
a Ta—Si—O ternary alloy thin film resistive element which is provided on the substrate to be disposed in the vicinity of the plurality of nozzles in the plurality of individual flow channels and has a self-oxide film at least on a surface in contact with the ink; and
a driving unit that generates heat energy for ejecting the ink from the plurality of nozzles with the Ta—Si—O ternary alloy thin film resistive element by applying electricity on the Ta—Si—O ternary alloy thin film resistive element,
the ink filled in the plurality of individual flow channels in the vicinity of the plurality of nozzles being ejected as ink droplets from the plurality of nozzles through expansion of bubbles formed in the ink with heat energy from the Ta—Si—O ternary alloy thin film resistive element, and the bubbles formed in the plurality of individual flow channels being connected to atmospheric air through the plurality of nozzles.

2. The ink-jet recording head as claimed in claim 1, wherein, upon ejecting the ink in the plurality of individual flow channels as ink droplets from the plurality of nozzles, the driving unit electrifies the Ta—Si—O ternary alloy thin film resistive element with a series of driving signals comprising one or plural driving pulses.

3. The ink-jet recording head as claimed in claim 2, wherein the driving unit electrifies the Ta—Si—O ternary alloy thin film resistive element with a series of driving signals comprising a pre-pulse and a main pulse, in which the pre-pulse is for preliminary heating the ink with the Ta—Si—O ternary alloy thin film resistive element with heat energy of such an extent that no bubble is formed, and the main pulse is for heating the ink with the Ta—Si—O ternary alloy thin film resistive element to form a bubble in the ink thus preliminary heated, and a number of the pre-pulse is changed depending on a temperature of the substrate.

4. The ink-jet recording head as claimed in claim 3, wherein time widths of the pre-pulses with which the Ta—Si—O ternary alloy thin film resistive element is electrified are equalized, and electrification intervals of the pre-pulse and the main pulse constituting the series of driving signals are equalized when the ink in the individual flow channels is ejected by the driving unit as an ink droplet from the nozzles.

5. The ink-jet recording head as claimed in claim 1, wherein an electrode for electrifying the Ta—Si—O ternary alloy thin film resistive element is provided on the substrate, and the electrode is covered with the Ta—Si—O ternary alloy thin film resistive element.

6. The ink-jet recording head as claimed in claim 1, wherein a plane shape of an ink contact surface of the Ta—Si—O ternary alloy thin film resistive element is a substantially square shape.

7. The ink-jet recording head as claimed in claim 6, wherein a diameter of the nozzle, a nozzle length from an inlet to an outlet of the nozzle, and a distance from the ink contact surface of the Ta—Si—O ternary alloy thin film resistive element to the inlet of the nozzle are substantially equal to about ½ of a length of one edge of the ink contact surface.

8. The ink-jet recording head as claimed in claim 7, wherein the ink contact surface has an area within a range of from 500 to 1,800 μm².

9. The ink-jet recording head as claimed in claim 7, wherein the ink in the individual flow channel is heated with the Ta—Si—O ternary alloy thin film resistive element so that the ink droplet thus ejected from the nozzle has a volume of from 2 to 16 pL.

10. The ink-jet recording head as claimed in claim 8, wherein the plurality of nozzles are arranged in an arranging direction thereof perpendicular to a head moving direction, which is a direction along which the ink-jet recording head is moved upon recording on a recording material and a pitch of the plurality of nozzles along the arranging direction is a length corresponding to a resolution of from 800 to 1,600 dpi.

11. An ink-jet recording apparatus comprising:
an ink-jet recording head comprising:
a plurality of nozzles for ejecting an ink;
a plurality of individual flow channels filled with the ink and connected to the plurality of nozzles;
a substrate constituting a part of an inner wall of the plurality of individual flow channels;
a Ta—Si—O ternary alloy thin film resistive element which is provided on the substrate to be disposed in the vicinity of the plurality of nozzles in the plurality of individual flow channels and has a self-oxide film at least on a surface in contact with the ink; and
a driving unit that generates heat energy for ejecting the ink from the plurality of nozzles with the Ta—Si—O ternary alloy thin film resistive element by applying electricity on the Ta—Si—O ternary alloy thin film resistive element,
wherein the ink filled in the plurality of individual flow channels in the vicinity of the plurality of nozzles is ejected as ink droplets from the plurality of nozzles through expansion of bubbles formed in the ink with heat energy from the Ta—Si—O ternary alloy thin film resistive element, and the bubbles formed in the plurality of individual flow channels are connected to atmospheric air through the plurality of nozzles, and
wherein the plurality of nozzles are arranged in an arranging direction thereof perpendicular to a head moving direction, which is a direction along which the ink-jet recording head is moved upon recording on a recording materials and a pitch of the plurality of nozzles along the arranging direction is a length corresponding to a resolution of from 800 to 1,600 dpi;
the ink-jet recording apparatus also comprising:
a head driving unit that drives the ink-jet recording head along a head moving direction; and
a conveying unit that conveys a recording material along the arranging direction of the plurality of nozzles relative to the ink-jet recording head.
